(19) United States
(12) Patent Application Publication
(10) Pub. No.: US 2024/0163241 A1
(43) Pub. Date: May 16, 2024

(54) METHODS AND SYSTEMS OF A PROVIDING PATIENT INSURANCE WITH A TRUSTED MESSENGER SOLUTION

(71) Applicant: VINEET GULATI, FREMONT, CA (US)

(72) Inventor: VINEET GULATI, FREMONT, CA (US)

(21) Appl. No.: 18/222,403

(22) Filed: Jul. 14, 2023

Related U.S. Application Data
(60) Provisional application No. 63/389,362, filed on Jul. 14, 2022.

(51) Int. Cl. H04L 51/52; H04L 51/21

(52) U.S. Cl. CPC H04L 51/52; H04L 51/21

(57) ABSTRACT

A method for managing a trusted messenger solution, further comprising: with at least one computer processor and a digital platform: creating a network of trusted community partnerships; determining a set of trusted local messengers that are trusted in a community; onboarding the set of trusted local messengers to the digital platform, wherein the digital platform comprises a set of digital communications systems that amplify a social network connection between the set of trusted local messengers with a set of community members such that each trusted local messenger of the set of trusted local messengers communicates at scale in the set of community members.

### CLAIM OF PRIORITY

This patent application claims priority to U.S. Provisional Patent Application No. 63/389,362, filed on 14 Jul. 2022 and titled METHODS AND SYSTEMS OF A PROVIDING PATIENT INSURANCE WITH A TRUSTED MESSENGER SOLUTION. This provisional patent application is hereby incorporated by reference in its entirety.

### BACKGROUND

There is a need for an equity-centered digital engagement platform that enables trusted messengers to have peer-to-peer and community communications with hard-to-reach populations at scale.

### SUMMARY OF THE INVENTION

A method for managing a trusted messenger solution, further comprising: with at least one computer processor and a digital platform: creating a network of trusted community partnerships; determining a set of trusted local messengers that are trusted in a community; onboarding the set of trusted local messengers to the digital platform, wherein the digital platform comprises a set of digital communications systems that amplify a social network connection between the set of trusted local messengers with a set of community members such that each trusted local messenger of the set of trusted local messengers communicates at scale in the set of community members; and enabling the set of trusted messengers to communicate in own voice and a local context and provide an insight about a need of the set of community members. BRIEF DESCRIPTION OF THE DRAWINGS

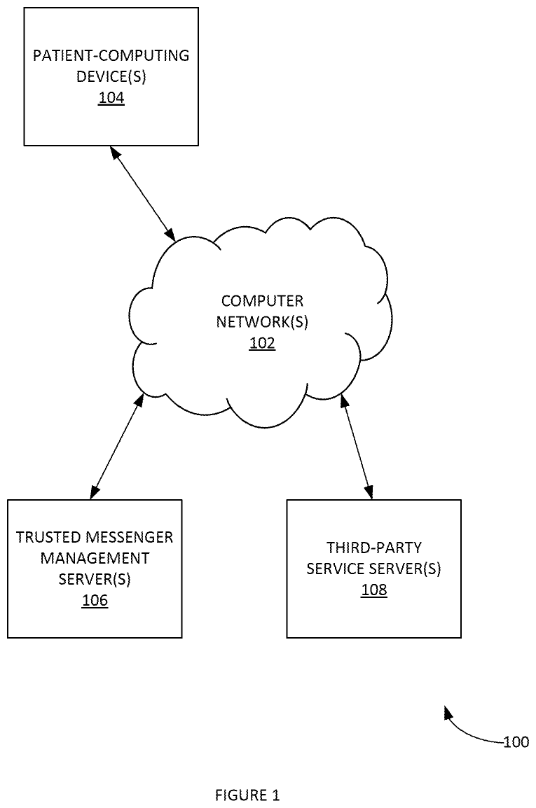

FIG. 1 illustrates an example system for health care/insurance solution as a service management, according to some embodiments.

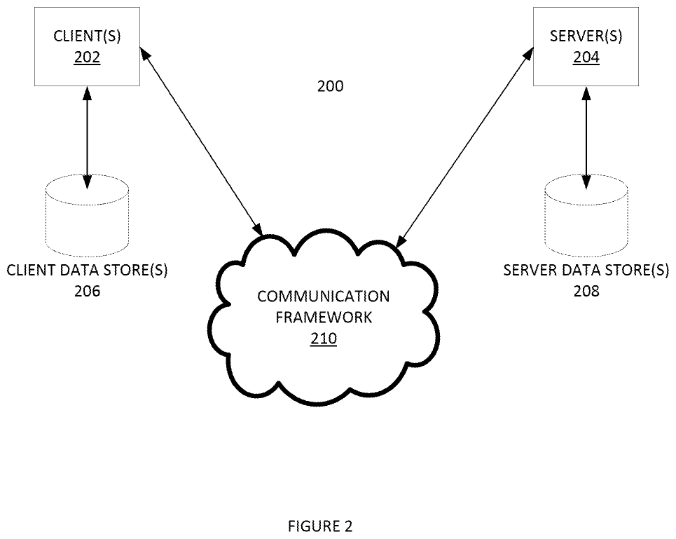

FIG. 2 depicts an exemplary computing system that can be configured to perform any one of the processes provided herein.

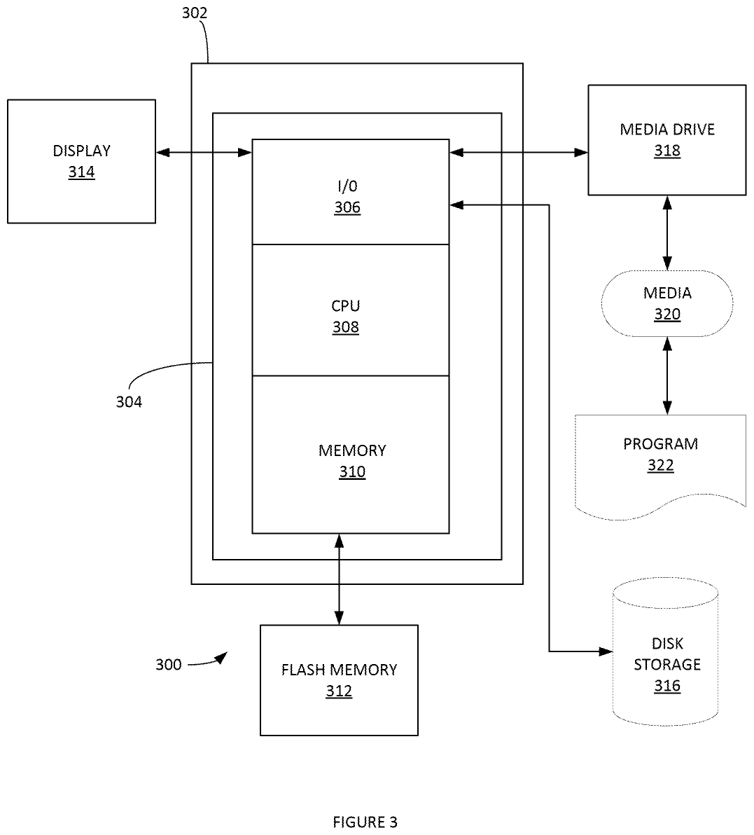

FIG. 3 is a block diagram of a sample computing environment that can be utilized to implement various embodiments.

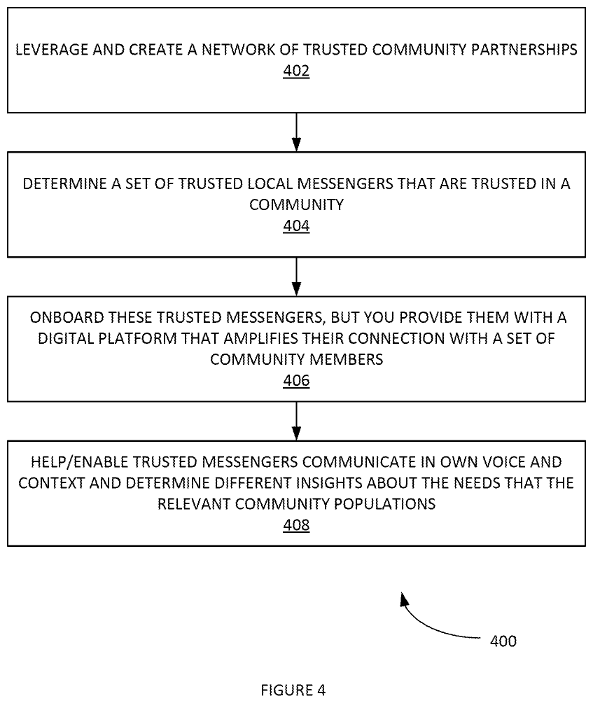

FIG. 4 illustrates an example process for managing a trusted messenger solution, according to some embodiments.

The Figures described above are a representative set and are not an exhaustive with respect to embodying the invention.

### DESCRIPTION

Disclosed are a system, method, and article of manufacture for providing patient insurance with a trusted messenger solution. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment, “an embodiment,”one example,’ or similar language means that a particular feature, structure, or characteristic described in connection with the embodiment is included in at least one embodiment of the present invention. Thus, appearances of the phrases ‘in one embodiment,’ in an embodiment,′ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application can be a computer program designed to perform a group of coordinated functions, tasks and/or activities for the benefit of the user.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

Machine learning is a type of artificial intelligence (AI) that provides computers with the ability to learn without being explicitly programmed. Machine learning focuses on the development of computer programs that can teach themselves to grow and change when exposed to new data.

Recommendation system can be a subclass of information filtering system that seeks to predict the ‘rating’ or ‘preference’ that a user would give to an item.

Social network is a social structure made up of a set of social actors (such as individuals or organizations), sets of dyadic ties, and other social interactions between actors. The social network perspective provides a set of methods for analyzing the structure of whole social entities as well as a variety of theories explaining the patterns observed in these structures. The study of these structures uses social network analysis to identify local and global patterns, locate influential entities, and examine network dynamics.

### Example Embodiments

.

### Example Computer Architecture and Systems

FIG. 1 illustrates an example system 100 for health care/insurance solution as a service management, according to some embodiments. System 100 can include various computer and/or cellular data networks 100. Networks 102 can include the Internet, text messaging networks (e.g. short messaging service (SMS) networks, multimedia messaging service (MMS) networks, proprietary messaging networks, instant messaging service networks, email systems, etc. Networks 102 can be used to communicate messages and/or other information from the various entities of system 100.

Patient-computing devices 104 can be any computing device used by a user to access information provided by application management server(s) 106. For example, patient-computing devices 104 can include a web browser, mobile-device application and the like. These can be used to perform the client-side steps of the processes provided infra.

Paysurrance management server(s) 106 can implement the various process provided herein. Paysurrance management server(s) 106 can aggregate data from various sources such as, inter alia: patient financial statements, employment information, medical expenses, insurance data, etc. and applies machine learning algorithms, artificial intelligence functions and other analytics to this data.

Trusted messenger management server(s) 106 can include various machine learning functionalities that can analyze patient behavior, finances, insurance options, patient segmentation and the like. Example machine-learning algorithms can include, inter alia: clustering, classification, RFM (Recency, Frequency and Monetary) analysis. The approach works on collaboratively implementing the following capabilities and continuous monitoring of results to improve the provider's financial outcomes and payer's member cost burdens. Trusted messenger management server(s) 106 can segment communities based on their demographic, social, health and financial status to predict/determine a set of trust messengers to interact with said communities. Trusted messenger management server(s) 106 can enable healthcare providers can offer communities various financial options ranging from point of care payments, lending, and other credit solutions without financial recourse to the healthcare provider as needed that are presented to the community via trust messengers.

Trusted messenger management server(s) 106 can include recommendation systems that can provide a set of ranked recommendations to patience based on the output of the machine learning functionalities, patient segmentation, etc. Trusted messenger management server(s) 106 can access third-party services server(s) 108 (e.g. healthcare provider servers, insurance company servers, medical care provider servers, etc.) to obtain additional information as needed.

Trusted messenger management server(s) 106 can implement community network and/or social network analysis to determine the identity of trusted messengers and their relationships within their respective communities. This can be based on various factors, including, inter alia: social, demographic, class, language, trade, educational, etc. Trusted messenger management server(s) 106 can translate communication into a various of languages and/or local vernaculars. These can include, inter alia: Mandarin, Spanish, Portuguese, Haitian French, Sign Language, Appalachian English, Black-American English, etc.

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

FIG. 2 depicts an exemplary computing system 200 that can be configured to perform any one of the processes provided herein. FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

Exemplary Trusted Messenger Solution Methods

FIG. 4 illustrates an example process 400 for managing a trusted messenger solution, according to some embodiments. In step 402, process 400 can leverage and create a network of trusted community partnerships. A person's health and well-being may not necessarily just be purely health, but also related to overall well being decisions. These can revolve around such factors as, inter alia: food choices, housing, mental well-being, etc.

In step 404, process 400 can determine a set of trusted local messengers that are trusted in a community. These can be community health workers, volunteers, faith-based workers, etc. The trusted local messengers can live within a community and have a trusted relationship with a potential customer/patient (e.g. a person an entity using process 400 is trying to engage with and influence change, etc.) Trusted local messengers can be part of these communities, they have a network comprising a plurality of relationships of trust.

In step 406, process can onboard these trusted messengers, but you provide them with a digital platform that amplifies their connection with a set of community members. In this way, the trust messenger can communicate at scale in the community (e.g. in own language, in own voice, etc.)

In step 408, process 400 can help/enable trusted messengers communicate in own voice and context and determine different insights about the needs that the relevant community populations.

In this way, process 400 uses/leverages a network-based approach of trusted messengers and, and, and giving them the voice and the power and the technology to communicate, engage, converse with their respective audiences. Process 400 can be used to define how we see what we do as being different from what traditionally happens and engagement and communication approaches, right. It is noted that process 400 can utilized various means of communication including, inter alia: mass media, email, media commercials, etc. In this way, process 400 can enable healthcare and/or insurance providers to connect with underserved communities using trust messengers to amply their signal.

Trusted messengers can understand what community needs are in terms of health care. Process 400 can be used to reach various off the grid communities as well (e.g. communities of color, etc.) and enhance engagement with these communities in a more productive manner. Trusted messengers can gather insights and data, because of the trusted relationships they have with the community.

Process 400 can enable micro engagements. Micro engagement can leverage various communication methods like SMS, social media messaging, etc. Trusted messengers can use micro communication campaigns when engaging with communities. It is noted that community members can interact with their health plan via a trust messenger. The Trusted messenger defines the message, the conversation, they want to have the content that they want to share the resource that they want to provide, and they do that through this platform as well. Contextuality can means language that is sensitive to the cultural context. In this way, process 400 can enable a process of textuality trust and micro communications as an as an integral part of connecting communities that have previously not engaged fully because of many factors, but principally because of a lack of trust in the, in the originator of the message or communication.

Process 400 can be used by, inter alia: community clinics or rural health centers, food pantries, philanthropic organizations, public health entities, etc. Trusted messengers can interact with/be health workers, priests, faith-based workers, etc.

In one example, trust messengers can send a micro message about the pop-up clinic for blood pressure, or could be a food, food event, etc. The micro message can in a language/vernacular that the community uses. In this way, process 400 can leverage and have a conversational exchange with that community.

Process 400 can provide workflows that include an Al enabled conversation with that community. Process 400 can suggest the kind of insights, people share very, sort of very personal information, because they feel comfortable doing so because they know the originator, the trusted messenger.

Process 400 can enable a trust messenger to survey a set of community members on an individual bases. The trusted messenger can ask a series of questions like: “hey, what time do you get up in the morning?”; “Do you take your meds?”; “If you don't take your meds? Why don't you take your meds?”, etc. Process 400 can store each response and thee can be aggregated in a data store (e.g. at a very individualized level, group level, etc.).

Process 400 can use Al functionalities. Al functionalities can analyze responses and come up with optimized actions on the part of health care providers and/or trusted messengers. The Al functionality can use those responses to make the campaign flow smarter, and/or determine what people what category of need people are serving, etc.

### Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alio: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (for example in cross-validation), the test dataset is also called a holdout dataset.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed is as follows:

1. A method for managing a trusted messenger solution, further comprising:
with at least one computer processor and a digital platform:
creating a network of trusted community partnerships;
determining a set of trusted local messengers that are trusted in a community;
onboarding the set of trusted local messengers to the digital platform, wherein the digital platform comprises a set of digital communications systems that amplify a social network connection between the set of trusted local messengers with a set of community members such that each trusted local messenger of the set of trusted local messengers communicates at scale in the set of community members; and
enabling the set of trusted messengers to communicate in own voice and a local context and provide an insight about a need of the set of community members.

2. The method of claim 1, wherein the set of set of trusted local messengers comprises a set of community health workers.

3. The method of claim 2, wherein the set of set of trusted local messengers comprises a set of community volunteers and community faith-based workers.

4. The method of claim 3, the set of set of trusted local messengers comprises live within a specified community and have a trusted relationship with a user.

5. The method of claim 4, wherein the user comprises a person a trusted local messenger is engaged with to influence a specified change.

6. The method of claim 5, wherein the insight about a need of the set of community members comprises a food choice information.

7. The method of claim 5, wherein the insight about a need of the set of community members comprises an affordable housing information.

8. The method of claim 5, wherein the insight about a need of the set of community members comprises a mental-health information.
